(19) United States
(12) Patent Application Publication
(10) Pub. No.: US 2026/0356025 A1
(43) Pub. Date: Nov. 12, 2026

(54) MULTI-LAYERED STRUCTURE AND BLEND AND METHOD OF RECYCLING THERMOPLASTIC POLYURETHANE

(71) Applicant: ICP DAS CO., LTD., Hukou Township (TW)

(72) Inventors: Jui Hsiang CHEN, Zhubei City (TW); Yu Hua CHEN, Hsinchu City (TW); Chia Chen TSAI, Hsinchu City (TW); Wen Hua CHEN, Hsinchu City (TW)

(73) Assignee: ICP DAS CO., LTD., Hukou Township (TW)

(21) Appl. No.: 19/205,426

(22) Filed: May 12, 2025

(30) Foreign Application Priority Data
May 6, 2025 (TW) 114116890

(51) Int. Cl. B29C 48/21; B29B 17/04; B29C 48/00; B29K 75/00; C08L 75/04

(52) U.S. Cl. CPC B29C 48/21; B29B 17/0412; B29C 48/022; C08L 75/04; B29K 2075/00; B29K 2995/0026; B29K 2995/007; B29K 2995/0077; B29K 2995/0097; C08L 2201/10; C08L 2205/025

(57) ABSTRACT

A multi-layered structure includes a hard thermoplastic polyurethane layer and a soft thermoplastic polyurethane layer disposed on and being in contact with the hard thermoplastic polyurethane layer. A method of recycling thermoplastic polyurethane includes recycling the multi-layered structure and blending the hard thermoplastic polyurethane layer and the soft thermoplastic polyurethane layer to form a blend. The blend has a haze degree of greater than or equal to 0% and less than 10%.

### CROSS REFERENCE TO RELATED APPLICATIONS

The present application is based on, and claims priority from, Taiwan Application Serial Number 114116890, filed on May 6, 2025, the disclosure of which is hereby incorporated by reference herein in its entirety.

### TECHNICAL FIELD

The technical field relates to a multi-layered structure, and in particular it relates to a method of recycling the multi-layered structure.

### BACKGROUND

The goal of orthodontic treatment is to move a patient's teeth into the optimal positions based on functional and aesthetic criteria. Traditionally, braces are applied to a patient's teeth by an orthodontist, and these braces apply a constant force (e.g. stress) to the teeth, which gradually push them toward the intended positions. After a series of clinical examinations and responsive adjustments to the braces over time, the braces can move the teeth into their final positions.

Ponitz used a transparent plastic film to fabricate a tooth retainer by vacuuming and thermoforming in 1971, and has demonstrated the general manufacturing method of modern invisible orthotic braces. Align Technology developed the first orthotic device made of a single layer of rigid polyurethane in 1998. Subsequently, Align Technology disclosed the multi-layer composite structure of soft layer/hard layer/soft layer and heterogeneous materials (e.g., two patents U.S. Pat. Nos. 9,655,691B2 and 9,655,693) in 2012, which provided gentler and more constant orthotic force to improve the control of tooth movement force. Patent U.S. Pat. No. 10,549,511B2 discloses a multi-layer structure of hard layer/soft layer/hard layer orthotic structure as invisible braces, which has higher flexibility and strength, as well as better anti-fouling and anti-peeling properties.

For satisfying the requirements of orthotic force and delaying stress relaxation at same time, most of the commercially available invisible braces are multi-layer composite structures composed of different heterogeneous polymer materials. Regardless of the order of arrangement of the soft and hard layers, most of the hard layer is made of polyester or copolyester materials, while most of the soft layer is made of thermoplastic elastomer materials such as thermoplastic polyurethane. The hard and soft layers are composite materials combining different materials.

The heterogeneous multi-layered composite invisible braces made of the different polymers described above are firstly fabricated by extruding a multi-layered sheet, punching out a circular or square film, then processing the shape of the braces with a vacuum forming machine dedicated to the braces, and trimming off the excess material to obtain the required braces. A lot of excess material needs to be discarded during the entire process (e.g., the excess material that is left over from punching out the film after extruding the multi-layered composite sheet of different materials, or the excess material from cutting the film after vacuum forming the braces, etc.), resulting in a large amount of waste and hence environmental problems. It is estimated that about 70% of the multi-layered composite sheet of different materials will become waste material from the extrusion process to the completion of invisible braces. In the process, it is difficult to recycle the excess material of multi-layered sheet made of different materials due to the overly large difference in hot melt processing temperatures. Even if the scrap material is recycled, the resulting blend is usually opaque, having a high haze degree, or having low strength, which limits the subsequent utilization value and application of the recycled materials. Therefore, most of the excess material of the multi-layered composite sheet used to produce invisible braces is incinerated, thereby generating a large amount of greenhouse gases and carbon emissions.

Accordingly, as the global market for invisible braces is growing rapidly, re-designing a sustainable, energy-efficient, and low-carbon product is called-for. A new material combination of the multi-layered structure is required to address the above issues.

### SUMMARY

One embodiment of the disclosure provides a multi-layered structure, including a hard thermoplastic polyurethane layer, and a soft thermoplastic polyurethane layer disposed on and being in contact with the hard thermoplastic polyurethane layer.

In some embodiments, the hard thermoplastic polyurethane layer has a Shore D hardness of 70 D to 85 D, a haze degree of 1% to 10%, an ultimate tensile strength of 6,000 psi to 9,100 psi, an ultimate elongation of 150% to 280%, and a weight average molecular weight of 30,000 to 300,000.

In some embodiments, the soft thermoplastic polyurethane layer has a Shore A hardness of 85 A to 98 A, a haze degree of 3% to 6%, an ultimate tensile strength of 6,200 psi to 7,500 psi, an ultimate elongation of 300% to 600%, and a weight average molecular weight of 60,000 to 250,000.

In some embodiments, the hard thermoplastic polyurethane layer and the soft thermoplastic polyurethane layer have a weight ratio of 1:1 to 3:1.

In some embodiments, the multi-layered structure is free of polymers other than thermoplastic polyurethane.

In some embodiments, the multi-layered structure has a thickness of 0.5 mm to 1.0 mm.

In some embodiments, the multi-layered structure further includes another hard thermoplastic polyurethane layer, wherein the soft thermoplastic polyurethane layer is interposed between the hard thermoplastic polyurethane layer and the another hard thermoplastic polyurethane layer, and the soft thermoplastic polyurethane layer is in contact with the another hard thermoplastic polyurethane layer.

In some embodiments, the multi-layered structure further includes another soft thermoplastic polyurethane layer, wherein the hard thermoplastic polyurethane layer is interposed between the soft thermoplastic polyurethane layer and the another soft thermoplastic polyurethane layer, and the hard thermoplastic polyurethane layer is in contact with the another soft thermoplastic polyurethane layer.

One embodiment of the disclosure provides a method of recycling thermoplastic polyurethane, including recycling the described multi-layered structure; and blending the hard thermoplastic polyurethane layer and the soft thermoplastic polyurethane layer to form a blend, wherein the blend has a haze degree of greater than or equal to 0% and less than 10%.

In some embodiments, the multi-layered structure is free of polymers other than thermoplastic polyurethane.

One embodiment of the disclosure provides a blend including a hard thermoplastic polyurethane; and a soft thermoplastic polyurethane, wherein the blend has a haze degree of greater than or equal to 0% and less than 10%.

In some embodiments, the blend is free of polymers other than thermoplastic polyurethane.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 shows a multi-layered structure in one embodiment of the disclosure.

FIG. 2 shows a multi-layered structure in one embodiment of the disclosure.

FIG. 3 shows a multi-layered structure in one embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

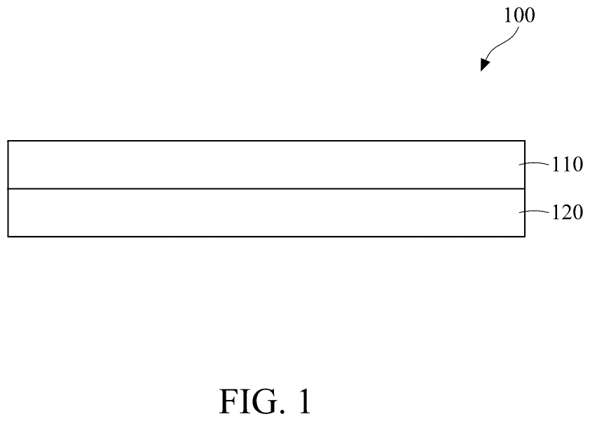

As shown in FIG. 1, one embodiment of the disclosure provides a multi-layered structure 100, including a hard thermoplastic polyurethane layer 110, and a soft thermoplastic polyurethane layer 120 disposed on and being in contact with the hard thermoplastic polyurethane layer 110. In other words, there is no adhesive layer or another layer between the hard thermoplastic polyurethane layer 110 and the soft thermoplastic polyurethane layer 120. While the hard thermoplastic polyurethane layer 110 and the soft thermoplastic polyurethane layer 120 are similar materials, there is no obvious interface between the two layers (con-firmed by an SEM photograph). When the multi-layered structure is applied as braces, the hard thermoplastic polyurethane layer 110 and the soft thermoplastic polyurethane layer 120 will not delaminate due to external force such as impact or friction, thereby continuously providing a constant stress. On the other hand, if the multi-layered structure is formed from different types of materials such as a hard thermoplastic polyester layer and the soft thermoplastic polyurethane layer, there will be an obvious interface between the hard thermoplastic polyester layer and the soft thermoplastic polyurethane layer. The multi-layered structure will be easily delaminated due to an external force and cannot provide a constant stress, thereby reducing the orthotic effect.

In some embodiments, the hard thermoplastic polyurethane layer 110 has a Shore D hardness of 70 D to 85 D, a haze degree of 1% to 10%, an ultimate tensile strength of 6,000 psi to 9,100 psi, an ultimate elongation of 150% to 280%, and a weight average molecular weight of 30,000 to 300,000. If the Shore D hardness of the hard thermoplastic polyurethane layer 110 is too high, the braces will be not easily worn and its wearing comfort will be poor due to the overly high rigidity of the braces. If the Shore D hardness of the hard thermoplastic polyurethane layer 110 is too low, the orthotic force will be too low due to the overly low rigidity of the braces. If the haze degree of the hard polyurethane layer 110 is too high, the haze degree of the multi-layered structure will be increased. If the tensile strength of the hard thermoplastic polyurethane layer 110 is too high, the braces will be difficult to wear. If the tensile strength of the hard thermoplastic polyurethane layer 110 is too low, the braces cannot provide a sufficient orthotic force. If the ultimate elongation of the hard thermoplastic polyurethane layer 110 is too low, the braces will be brittle and easily cracked, thereby terminating the orthotic treatment. If the weight average molecular weight of the hard thermoplastic polyurethane layer 110 is too high, the processing temperature will be too high, resulting in thermal degradation of the material, which will also make the material difficult and energy intensive to process. If the weight average molecular weight of the hard thermoplastic polyurethane layer 110 is too low, the processing temperature will be too low and the physical properties of the braces will be insufficient.

In some embodiments, the soft thermoplastic polyurethane layer 120 has a Shore A hardness of 85 A to 98 A, a haze degree of 3% to 6%, an ultimate tensile strength of 6,200 psi to 7,500 psi, an ultimate elongation of 300% to 600%, and a weight average molecular weight of 60,000 to 250,000. The Shore A hardness and the Shore D hardness are used to measure the hardness of a soft material and a hard material, respectively. The Shore A hardness is ranged from 0 A (most soft) to 100 A (most hard), and the Shore D hardness is ranged from 0 D (most soft) to 100 D (most hard). A Shore A hardness of 98 A can be converted to a shore D hardness of 60 D. A Shore A hardness of 85 A can be converted to a shore D hardness of 3 5D. Accordingly, the soft thermoplastic polyurethane layer 120 has the shore A hardness of 85 A to 98 A, which can be roughly converted to the shore D hardness of 35 D to 60 D. As such, the hardness of the soft thermoplastic polyurethane layer 120 can be represented as 85 A to 60 D. If the Shore A hardness of the soft thermoplastic polyurethane layer 120 is too high, its elasticity will be insufficient. If the Shore A hardness of the soft thermoplastic polyurethane layer 120 is too low, its physical properties will be insufficient and its surface friction will be too high. If the haze degree of the soft thermoplastic polyurethane layer 120 is too high, the haze degree of the multi-layered structure will be increased. If the tensile strength of the soft thermoplastic polyurethane layer 120 is too low, the physical properties of the braces will be poor. If the ultimate elongation of the soft thermoplastic polyurethane layer 120 is too low, the braces will be easily crack and have poor physical properties. If the weight average molecular weight of the soft thermoplastic polyurethane layer 120 is too high, the processing temperature will be too high, resulting in thermal degradation of the material, which will also make the material difficult and energy intensive to process. If the weight average molecular weight of the soft thermoplastic polyurethane layer 120 is too low, the processing temperature will be too low and the physical properties of the braces will be insufficient.

In some embodiments, the hard thermoplastic polyurethane layer 110 and the soft thermoplastic polyurethane layer 120 have a weight ratio of 1:1 to 3:1, such as 2:1. If the amount of the hard thermoplastic polyurethane layer 110 is too high or too low, the multi-layered structure may not achieve the required physical properties of the product (e.g., braces).

In some embodiments, the multi-layered structure is free of polymers other than thermoplastic polyurethane (e.g., polyester, polyamide, polyimide, polyacrylic acid, poly-acrylate, or another polymer). As described above, the polymer other than the thermoplastic polyurethane may cause the delamination of the multi-layered structure, and further increase the haze degree and decrease the physical properties of the blend recycled from the multi-layered structure.

In some embodiments, the multi-layered structure has a thickness of 0.5 mm to 1.0 mm. In some embodiments, the multi-layered structure has a thickness of 0.6 mm to 0.9 mm. The multi-layered structure can be used to form the braces. Alternatively, the thickness of the multi-layered structure can be greater than or less the above range, depending upon its application.

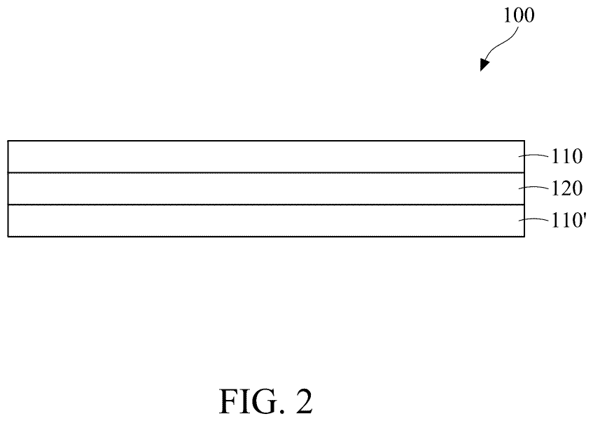

As shown in FIG. 2, the multi-layered structure 100 may further includes another hard thermoplastic polyurethane layer 110′, wherein the soft thermoplastic polyurethane layer 120 is interposed between the hard thermoplastic polyurethane layer 110 and the another hard thermoplastic polyurethane layer 110′, and the soft thermoplastic polyurethane layer 120 is in contact with the another hard thermoplastic polyurethane layer 110'. The another hard thermoplastic polyurethane layer 110′ has properties similar to or same as those of the hard thermoplastic polyurethane layer 110. In addition, the another hard thermoplastic polyurethane layer 110′ has a thickness similar to or same as that of the hard thermoplastic polyurethane layer 110.

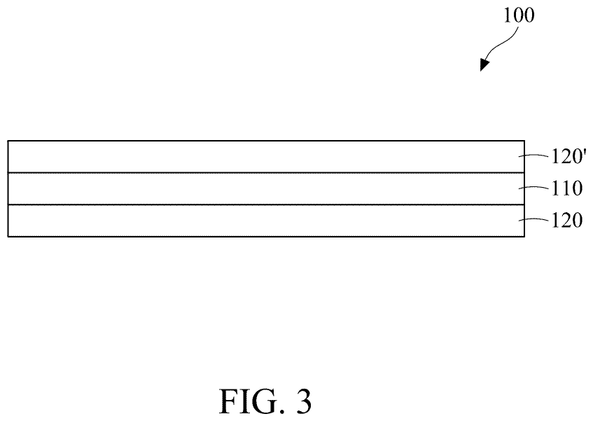

As shown in FIG. 3, the multi-layered structure 100 further includes another soft thermoplastic polyurethane layer 120′, wherein the hard thermoplastic polyurethane layer 110 is interposed between the soft thermoplastic polyurethane layer 120 and the another soft thermoplastic polyurethane layer 120′, and the hard thermoplastic polyurethane layer 110 is in contact with the another soft thermoplastic polyurethane layer 120′. The another soft thermoplastic polyurethane layer 120′ has properties similar to or same as those of the soft thermoplastic polyurethane layer 120. In addition, the another soft thermoplastic polyurethane layer 120′ has a thickness similar to or same as that of the soft thermoplastic polyurethane layer 120.

In addition to the above-mentioned two-layered or three-layered multilayer structure 100, the multi-layered structure 100 may also be a multi-layered structure with four layers, five layers, six layers, or more layers (not shown), which contains alternating hard thermoplastic polyurethane layers 110 (and the another hard thermoplastic polyurethane layer 110′) and soft thermoplastic polyurethane layers 120 (and the another soft thermoplastic polyurethane layer 120′). It should be understood no matter the number of the hard thermoplastic polyurethane layers and the soft thermoplastic polyurethane layers contained in the multilayer structure 100, the hard thermoplastic polyurethane layers and the soft thermoplastic polyurethane layers still have a weight ratio of 1:1 to 3:1.

One embodiment of the disclosure provides a method of recycling thermoplastic polyurethane, including recycling the described multi-layered structure 100; and blending the hard thermoplastic polyurethane layer 110 and the soft thermoplastic polyurethane layer 120 to form a blend, wherein the blend has a haze degree of greater than or equal to 0% and less than 10%. Subsequently, the blend can be processed to obtain storage box, Luer taper, or other products with a low haze degree.

Accordingly, the disclosure provides a multi-layered structure 100 formed from the hard thermoplastic polyurethane layer 110 and the soft thermoplastic polyurethane layer 120. The multi-layered structure 100 is free of another polymer other than the thermoplastic polyurethane, such that the multi-layered structure 100 can be recycled to form a blend having a low haze degree and high physical properties. Compared to the currently common multi-layered structure (especially the multi-layered structure for braces), the disclosure may greatly increase the application fields of the recycled multi-layered structure.

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omit-ted for clarity, and like reference numerals refer to like elements throughout.

### EXAMPLES

In following Examples, the soft thermoplastic polyurethane, the hard thermoplastic polyurethane, and the hard polyester were processed to obtain a sheet having a thickness of 2 mm. The haze degrees of the sheet and the polymers were measured according to the standard ASTM D1003, the ultimate tensile strengths of the sheet and the polymers were measured according to the standard ASTM D412, the ultimate elongation of the sheet and the polymers were measured according to the standard ASTM D412, and the weight average molecular weight of the polymer was measured by GPC (with the PEG/PEO standard). The Shore A hardness of the soft thermoplastic polyurethane was measured according to the standard ASTM D2240, and the Shore D hardness of the hard thermoplastic polyurethane was measured according to the standard ASTM D2240. The multi-layered structure was recycled, blended, re-pelletized, and then processed to obtain a sheet having a thickness of 2 mm. The haze degree, ultimate tensile strength, and ultimate elongation of the sheet and the blend were measured according the standard mentioned above.

### Example 1 -1

A soft thermoplastic polyurethane (ARP-85 A commercially available from ICP DAS-BMP, having a Shore A hardness of 85 A, a haze degree of 3.5%, an ultimate tensile strength of 6,200 psi, an ultimate elongation of 590%, and a weight average molecular weight of 60,000 to 200,000) and a hard thermoplastic polyurethane (EARP-78D commercially available from ICP DAS-BMP, having a Shore D hardness of 78 D, a haze degree of 1.7%, an ultimate tensile strength of 6,200 psi, an ultimate elongation of 175%, and a weight average molecular weight of 30,000 to 300,000) were co-extruded to form a three-layered structure (having a thickness of 0.7 mm to 0.8 mm) of hard thermoplastic polyurethane layer/soft thermoplastic polyurethane layer/hard thermoplastic polyurethane layer. In the three-layered structure, thicknesses of the two hard thermoplastic polyurethane layers were substantially the same, and the hard thermoplastic polyurethane layers and the soft thermoplastic polyurethane layer had a weight ratio of 2:1. As shown in the SEM microscope photograph, there was no obvious interface between the hard thermoplastic polyurethane layer and the soft thermoplastic polyurethane layer. As shown in the analysis of sampling different thicknesses of the multi-layered structure, the hard thermoplastic polyurethane layers and the soft thermoplastic polyurethane layer still maintained their individual compositions without being blended. The multi-layered structure had a transparent appearance.

The multi-layered structure was then disposed in a pelletizer to be blended to from a blend, re-pelletized, and processed to form a sheet having a thickness of 2 mm. The blend had a hardness of 68 D (measured according to the standard ASTM D2240). The sheet had a haze degree of 8%, an ultimate tensile strength of 6,832±202 psi, and an ultimate elongation of 266±5%. As shown above, the recycled multi-layered structure could form the blend of the low haze degree and the high physical properties.

### Example 1-2

The soft thermoplastic polyurethane ARP-85 A and a hard thermoplastic polyurethane (EARP-80 D commercially available from ICP DAS-BMP, having a Shore D hardness of 80 D, a haze degree of 1.6%, an ultimate tensile strength of 6,900 psi, an ultimate elongation of 160%, and a weight average molecular weight of 30,000 to 300,000) were co-extruded to form a three-layered structure (having a thickness of 0.7 mm to 0.8 mm) of hard thermoplastic polyurethane layer/soft thermoplastic polyurethane layer/hard thermoplastic polyurethane layer. In the three-layered structure, thicknesses of the two hard thermoplastic polyurethane layers were substantially the same, and the hard thermoplastic polyurethane layers and the soft thermoplastic polyurethane layer had a weight ratio of 2:1. As shown in the SEM microscope photograph, there was no obvious interface between the hard thermoplastic polyurethane layer and the soft thermoplastic polyurethane layer. As shown in the analysis of sampling different thicknesses of the multi-layered structure, the hard thermoplastic polyurethane layers and the soft thermoplastic polyurethane layer still maintained their individual compositions without being blended. The multi-layered structure had a transparent appearance.

The multi-layered structure was then disposed in a pelletizer to be blended to from a blend, re-pelletized, and processed to form a sheet having a thickness of 2 mm. The blend had a hardness of 67 D (measured according to the standard ASTM D2240). The sheet had a haze degree of 5%, an ultimate tensile strength of 7,073±334 psi, and an ultimate elongation of 273±17%. As shown above, the recycled multi-layered structure could form the blend of the low haze degree and the high physical properties.

### Example 1-3

The soft thermoplastic polyurethane ARP-85 A and a hard thermoplastic polyurethane (EARP-81 D commercially available from ICP DAS-BMP, having a Shore D hardness of 81 D, a haze degree of 2%, an ultimate tensile strength of 7,600 psi, an ultimate elongation of 150%, and a weight average molecular weight of 30,000 to 300,000) were co-extruded to form a three-layered structure (having a thickness of 0.7 mm to 0.8 mm) of hard thermoplastic polyurethane layer/soft thermoplastic polyurethane layer/hard thermoplastic polyurethane layer. In the three-layered structure, thicknesses of the two hard thermoplastic polyurethane layers were substantially the same, and the hard thermoplastic polyurethane layers and the soft thermoplastic polyurethane layer had a weight ratio of 2:1. As shown in the SEM microscope photograph, there was no obvious interface between the hard thermoplastic polyurethane layer and the soft thermoplastic polyurethane layer. As shown in the analysis of sampling different thicknesses of the multi-layered structure, the hard thermoplastic polyurethane layers and the soft thermoplastic polyurethane layer still maintained their individual compositions without being blended. The multi-layered structure had a transparent appearance.

The multi-layered structure was then disposed in a pelletizer to be blended to from a blend, re-pelletized, and processed to form a sheet having a thickness of 2 mm. The blend had a hardness of 74 D (measured according to the standard ASTM D2240). The sheet had a haze degree of 2%, an ultimate tensile strength of 5,498±110 psi, and an ultimate elongation of 230±37%. As shown above, the recycled multi-layered structure could form the blend of the low haze degree and the high physical properties.

### Example 1-4

The soft thermoplastic polyurethane ARP-85 A and a hard thermoplastic polyurethane (Isoplast 2530 commercially available from Lubrizol Corporation, having a Shore D hardness of 80 D, a haze degree of about 10%, an ultimate tensile strength of 9,015±867 psi, an ultimate elongation of 187±72%, and a weight average molecular weight of 100,000 to 200,000) were co-extruded to form a three-layered structure (having a thickness of 0.7 mm to 0.8 mm) of soft thermoplastic polyurethane layer/hard thermoplastic polyurethane layer/soft thermoplastic polyurethane layer. In the three-layered structure, thicknesses of the two soft thermoplastic polyurethane layers were substantially the same, and the hard thermoplastic polyurethane layer and the soft thermoplastic polyurethane layers had a weight ratio of 2:1. As shown in the SEM microscope photograph, there was no obvious interface between the hard thermoplastic polyurethane layer and the soft thermoplastic polyurethane layer. As shown in the analysis of sampling different thicknesses of the multi-layered structure, the hard thermoplastic polyurethane layer and the soft thermoplastic polyurethane layers still maintained their individual compositions without being blended. The multi-layered structure had a transparent appearance.

The multi-layered structure was then disposed in a pelletizer to be blended to from a blend, re-pelletized, and processed to form a sheet having a thickness of 2 mm. The blend had a hardness of 80 D (measured according to the standard ASTM D2240). The sheet had a haze degree of 7.5%, an ultimate tensile strength of 6,364±567 psi, and an ultimate elongation of 160±128%. As shown above, the recycled multi-layered structure could form the blend of the low haze degree and the high physical properties.

### Comparative Example 1 -1

The soft thermoplastic polyurethane ARP-85 A and a hard thermoplastic polyester (Eastar GN071 commercially available from Eastman, having a Shore D hardness of 76 D, a haze degree of 1.7%, an ultimate tensile strength of 3,973±181 psi, an ultimate elongation of 31±31%) were co-extruded to form a three-layered structure (having a thickness of 0.7 mm to 0.8 mm) of hard thermoplastic polyester layer/soft thermoplastic polyurethane layer/hard thermoplastic polyester layer. In the three-layered structure, thicknesses of the two hard thermoplastic polyester layers were substantially the same, and the hard thermoplastic polyester layers and the soft thermoplastic polyurethane layer had a weight ratio of 2:1. As shown in the SEM microscope photograph, there was an obvious interface between the hard thermoplastic polyester layer and the soft thermoplastic polyurethane layer. As shown in the analysis of sampling different thicknesses of the multi-layered structure, the hard thermoplastic polyester layers and the soft thermoplastic polyurethane layer still maintained their individual compositions without being blended. The multi-layered structure had a transparent appearance.

The multi-layered structure was then disposed in a pelletizer to be blended to from a blend, re-pelletized, and processed to form a sheet having a thickness of 2 mm. The blend had a hardness of 67 D (measured according to the standard ASTM D2240). The sheet had a haze degree of 87%, an ultimate tensile strength of 4,156±80 psi, and an ultimate elongation of 80±23%. As shown above, the recycled multi-layered structure could form the blend of the high haze degree and the low physical properties.

### Comparative Example 1-2

The soft thermoplastic polyurethane ARP-85 A and a hard thermoplastic polyester (Tritan MP100 commercially available from Eastman, having a Shore D hardness of 77 D, a haze degree of 1.1%, an ultimate tensile strength of 7,037±260 psi, and an ultimate elongation of 136±5%) were co-extruded to form a three-layered structure (having a thickness of 0.7 mm to 0.8 mm) of soft thermoplastic polyurethane layer/hard thermoplastic polyester layer/soft thermoplastic polyurethane layer. In the three-layered structure, thicknesses of the two soft thermoplastic polyurethane layers were substantially the same, and the hard thermoplastic polyester layer and the soft thermoplastic polyurethane layers had a weight ratio of 2:1. As shown in the SEM microscope photograph, there was an obvious interface between the hard thermoplastic polyester layer and the soft thermoplastic polyurethane layer. As shown in the analysis of sampling different thicknesses of the multi-layered structure, the hard thermoplastic polyester layer and the soft thermoplastic polyurethane layers still maintained their individual compositions without being blended. The multi-layered structure had a transparent appearance.

The multi-layered structure was then disposed in a pelletizer to be blended to from a blend, re-pelletized, and processed to form a sheet having a thickness of 2 mm. The blend had a hardness of 68 D (measured according to the standard ASTM D2240). The sheet had a haze degree of 87%, an ultimate tensile strength of 4,446±118 psi, and an ultimate elongation of 108±16%. As shown above, the recycled multi-layered structure could form the blend of the high haze degree and the low physical properties.

### Example 2-1

A soft thermoplastic polyurethane (ARP-90 A commercially available from ICP DAS-BMP, having a Shore A hardness of 90 A, a haze degree of about 5.6%, an ultimate tensile strength of 7,300 psi, an ultimate elongation of 540%, and a weight average molecular weight of 60,000 to 250,000) and the hard thermoplastic polyurethane EARP-78D were co-extruded to form a three-layered structure (having a thickness of 0.7 mm to 0.8 mm) of hard thermoplastic polyurethane layer/soft thermoplastic polyurethane layer/hard thermoplastic polyurethane layer. In the three-layered structure, thicknesses of the two hard thermoplastic polyurethane layers were substantially the same, and the hard thermoplastic polyurethane layers and the soft thermoplastic polyurethane layer had a weight ratio of 2:1. As shown in the SEM microscope photograph, there was no obvious interface between the hard thermoplastic polyurethane layer and the soft thermoplastic polyurethane layer. As shown in the analysis of sampling different thicknesses of the multi-layered structure, the hard thermoplastic polyurethane layers and the soft thermoplastic polyurethane layer still maintained their individual compositions without being blended. The multi-layered structure had a transparent appearance.

The multi-layered structure was then disposed in a pelletizer to be blended to from a blend, re-pelletized, and processed to form a sheet having a thickness of 2 mm. The blend had a hardness of 72 D (measured according to the standard ASTM D2240). The sheet had a haze degree of 7%, an ultimate tensile strength of 7,023±636 psi, and an ultimate elongation of 232±16%. As shown above, the recycled multi-layered structure could form the blend of the low haze degree and the high physical properties.

### Example 2 -2

The soft thermoplastic polyurethane ARP-90 A and the hard thermoplastic polyurethane EARP-80 D were co-extruded to form a three-layered structure (having a thickness of 0.7 mm to 0.8 mm) of hard thermoplastic polyurethane layer/soft thermoplastic polyurethane layer/hard thermoplastic polyurethane layer. In the three-layered structure, thicknesses of the two hard thermoplastic polyurethane layers were substantially the same, and the hard thermoplastic polyurethane layers and the soft thermoplastic polyurethane layer had a weight ratio of 2:1. As shown in the SEM microscope photograph, there was no obvious interface between the hard thermoplastic polyurethane layer and the soft thermoplastic polyurethane layer. As shown in the analysis of sampling different thicknesses of the multi-layered structure, the hard thermoplastic polyurethane layers and the soft thermoplastic polyurethane layer still maintained their individual compositions without being blended. The multi-layered structure had a transparent appearance.

The multi-layered structure was then disposed in a pelletizer to be blended to from a blend, re-pelletized, and processed to form a sheet having a thickness of 2 mm. The blend had a hardness of 71 D (measured according to the standard ASTM D2240). The sheet had a haze degree of 3%, an ultimate tensile strength of 7,587±108 psi, and an ultimate elongation of 244±5%. As shown above, the recycled multi-layered structure could form the blend of the low haze degree and the high physical properties.

### Example 2-3

The soft thermoplastic polyurethane ARP-90 A and the hard thermoplastic polyurethane EARP-81 D were co-extruded to form a three-layered structure (having a thickness of 0.7 mm to 0.8 mm) of hard thermoplastic polyurethane layer/soft thermoplastic polyurethane layer/hard thermoplastic polyurethane layer. In the three-layered structure, thicknesses of the two hard thermoplastic polyurethane layers were substantially the same, and the hard thermoplastic polyurethane layers and the soft thermoplastic polyurethane layer had a weight ratio of 2:1. As shown in the SEM microscope photograph, there was no obvious interface between the hard thermoplastic polyurethane layer and the soft thermoplastic polyurethane layer. As shown in the analysis of sampling different thicknesses of the multi-layered structure, the hard thermoplastic polyurethane layers and the soft thermoplastic polyurethane layer still maintained their individual compositions without being blended. The multi-layered structure had a transparent appearance.

The multi-layered structure was then disposed in a pelletizer to be blended to from a blend, re-pelletized, and processed to form a sheet having a thickness of 2 mm. The blend had a hardness of 77 D (measured according to the standard ASTM D2240). The sheet had a haze degree of 2%, an ultimate tensile strength of 6,117±111 psi, and an ultimate elongation of 91±77%. As shown above, the recycled multi-layered structure could form the blend of the low haze degree and the high physical properties.

### Example 2-4

The soft thermoplastic polyurethane ARP-90 A and the hard thermoplastic polyurethane Isoplast 2530 were co-extruded to form a three-layered structure (having a thickness of 0.7 mm to 0.8 mm) of soft thermoplastic polyurethane layer/hard thermoplastic polyurethane layer/soft thermoplastic polyurethane layer. In the three-layered structure, thicknesses of the two soft thermoplastic polyurethane layers were substantially the same, and the hard thermoplastic polyurethane layer and the soft thermoplastic polyurethane layers had a weight ratio of 2:1. As shown in the SEM microscope photograph, there was no obvious interface between the hard thermoplastic polyurethane layer and the soft thermoplastic polyurethane layer. As shown in the analysis of sampling different thicknesses of the multi-layered structure, the hard thermoplastic polyurethane layer and the soft thermoplastic polyurethane layers still maintained their individual compositions without being blended. The multi-layered structure had a transparent appearance.

The multi-layered structure was then disposed in a pelletizer to be blended to from a blend, re-pelletized, and processed to form a sheet having a thickness of 2 mm. The blend had a hardness of 80 D (measured according to the standard ASTM D2240). The sheet had a haze degree of 1.4%, an ultimate tensile strength of 7,363±337 psi, and an ultimate elongation of 246±89%. As shown above, the recycled multi-layered structure could form the blend of the low haze degree and the high physical properties.

### Comparative Example 2-1

The soft thermoplastic polyurethane ARP-90 A and the hard thermoplastic polyester Eastar GN071 were co-extruded to form a three-layered structure (having a thickness of 0.7 mm to 0.8 mm) of hard thermoplastic polyester layer/soft thermoplastic polyurethane layer/hard thermoplastic polyester layer. In the three-layered structure, thicknesses of the two hard thermoplastic polyester layers were substantially the same, and the hard thermoplastic polyester layers and the soft thermoplastic polyurethane layer had a weight ratio of 2:1. As shown in the SEM microscope photograph, there was an obvious interface between the hard thermoplastic polyester layer and the soft thermoplastic polyurethane layer. As shown in the analysis of sampling different thicknesses of the multi-layered structure, the hard thermoplastic polyester layers and the soft thermoplastic polyurethane layer still maintained their individual compositions without being blended. The multi-layered structure had a transparent appearance.

The multi-layered structure was then disposed in a pelletizer to be blended to from a blend, re-pelletized, and processed to form a sheet having a thickness of 2 mm. The blend had a hardness of 73 D (measured according to the standard ASTM D2240). The sheet had a haze degree of 77%, an ultimate tensile strength of 4,512±82 psi, and an ultimate elongation of 92±23%. As shown above, the recycled multi-layered structure could form the blend of the high haze degree and the low physical properties.

### Comparative Example 2 -2

The soft thermoplastic polyurethane ARP-90 A and the hard thermoplastic polyester Tritan MP100 were co-extruded to form a three-layered structure (having a thickness of 0.7 mm to 0.8 mm) of hard thermoplastic polyester layer/soft thermoplastic polyurethane layer/hard thermoplastic polyester layer. In the three-layered structure, thicknesses of the two hard thermoplastic polyester layers were substantially the same, and the hard thermoplastic polyester layers and the soft thermoplastic polyurethane layer had a weight ratio of 2:1. As shown in the SEM microscope photograph, there was an obvious interface between the hard thermoplastic polyester layer and the soft thermoplastic polyurethane layer. As shown in the analysis of sampling different thicknesses of the multi-layered structure, the hard thermoplastic polyester layers and the soft thermoplastic polyurethane layer still maintained their individual compositions without being blended. The multi-layered structure had a transparent appearance.

The multi-layered structure was then disposed in a pelletizer to be blended to from a blend, re-pelletized, and processed to form a sheet having a thickness of 2 mm. The blend had a hardness of 73 D (measured according to the standard ASTM D2240). The sheet had a haze degree of 41%, an ultimate tensile strength of 5,972±140 psi, and an ultimate elongation of 117±6%. As shown above, the recycled multi-layered structure could form the blend of the high haze degree and the low physical properties.

As shown above, after recycling and blending the multi-layered structure formed from the hard thermoplastic polyester layer and the soft thermoplastic polyurethane layer, the blend had a haze degree that was too high and physical properties that were too low (com-pared to the recycled blend of the multi-layered structure formed from the hard thermoplastic polyurethane layer and the soft thermoplastic polyurethane layer).

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A multi-layered structure, comprising:
a hard thermoplastic polyurethane layer; and
a soft thermoplastic polyurethane layer disposed on and being in contact with the hard thermoplastic polyurethane layer.

2. The multi-layered structure as claimed in claim 1, wherein the hard thermoplastic polyurethane layer has a Shore D hardness of 70 D to 85 D, a haze degree of 1% to 10%, an ultimate tensile strength of 6,000 psi to 9,100 psi, an ultimate elongation of 150% to 280%, and a weight average molecular weight of 30,000 to 300,000.

3. The multi-layered structure as claimed in claim 1, wherein the soft thermoplastic polyurethane layer has a Shore A hardness of 85 A to 98 A, a haze degree of 3% to 6%, an ultimate tensile strength of 6,200 psi to 7,500 psi, an ultimate elongation of 300% to 600%, and a weight average molecular weight of 60,000 to 250,000.

4. The multi-layered structure as claimed in claim 1, wherein the hard thermoplastic polyurethane layer and the soft thermoplastic polyurethane layer have a weight ratio of 1:1 to 3:1.

5. The multi-layered structure as claimed in claim 1, wherein the multi-layered structure is free of polymers other than thermoplastic polyurethane.

6. The multi-layered structure as claimed in claim 1, wherein the multi-layered structure has a thickness of 0.5 mm to 1.0 mm.

7. The multi-layered structure as claimed in claim 1, further comprising another hard thermoplastic polyurethane layer, wherein the soft thermoplastic polyurethane layer is interposed between the hard thermoplastic polyurethane layer and the another hard thermoplastic polyurethane layer, and the soft thermoplastic polyurethane layer is in contact with the another hard thermoplastic polyurethane layer.

8. The multi-layered structure as claimed in claim 1, further comprising another soft thermoplastic polyurethane layer, wherein the hard thermoplastic polyurethane layer is interposed between the soft thermoplastic polyurethane layer and the another soft thermoplastic polyurethane layer, and the hard thermoplastic polyurethane layer is in contact with the another soft thermoplastic polyurethane layer.

9. A method of recycling thermoplastic polyurethane, comprising:
recycling the multi-layered structure as claimed in claim 1; and
blending the hard thermoplastic polyurethane layer and the soft thermoplastic polyurethane layer to form a blend, wherein the blend has a haze degree of greater than or equal to 0% and less than 10%.

10. The method as claimed in claim 9, wherein the multi-layered structure is free of polymers other than thermoplastic polyurethane.

11. A blend, comprising:
a hard thermoplastic polyurethane; and
a soft thermoplastic polyurethane,
wherein the blend has a haze degree of greater than or equal to 0% and less than 10%.

12. The blend as claimed in claim 11, wherein the blend is free of polymers other than thermoplastic polyurethane.
